(19) United States
(12) Patent Application Publication
(10) Pub. No.: US 2008/0213420 A1
(43) Pub. Date: Sep. 4, 2008

(54) Stamper and method of manufacturing the same

(75) Inventors: Shinobu Sugimura, Yokohama-shi (JP); Yoshiyuki Kamata, Tokyo (JP); Seiji Morita, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/068,118

(22) Filed: Feb. 1, 2008

(30) Foreign Application Priority Data
Feb. 6, 2007 (JP) 2007-027119

(51) Int. Cl. B29C 59/00; C25D 7/00; C22C 19/03

(52) U.S. Cl. 425/385; 205/184; 420/441

(57) ABSTRACT

A stamper includes a stamper body including a nickel having a patterned surface by artificial drawing method, and a surface layer of a nickel-vanadium alloy having a vanadium content of less than 3 atomic percent formed on the patterned surface.

### CROSS-REFERENCE TO RELATED APPLICATIONS

This application is based upon and claims the benefit of priority from prior Japanese Patent Application No. 2007-027119, filed Feb. 6, 2007, the entire contents of which are incorporated herein by reference.

### BACKGROUND OF THE INVENTION

1. Field of the Invention

The present invention relates to a stamper for injection molding or imprinting technique used in the manufacture of recording media and a method of manufacturing the same.

2. Description of the Related Art

With the recent improvement of the recording density of recording media, patterns formed on the media have become finer. In order to mass-produce these recording media, a method is used in which a master is prepared having patterns thereon, a metallic stamper is formed by transferring the patterns of the master, and media having desired patterns are manufactured by further transferring the patterns of the stamper by injection molding or imprinting.

The manufacture of the stamper with the fine patterns requires a fine processing technique for forming protrusions of about 100 nm or less. A typical method of manufacturing a stamper employs electron-beam (EB) lithography and electroforming, and is generally performed in the following manner.

First, a silicon wafer is coated with EB resist to which patterns are drawn by EB lithography. Then, the resist is developed to fabricate a master having patterns of the resist thereon. A nickel conductive film is formed on the patterned surface of the master by sputtering, and then a nickel electroformed layer is formed by electroforming. The nickel conductive film and the nickel electroformed layer employ substantially the same material (nickel). The electroformed layer and the conductive film are stripped from the master, and then subjected to processes for cleaning, back polishing, and punching to manufacture a stamper.

According to the method described above, however, the adhesion between the nickel conductive film and EB resist is not good enough, so that the nickel conductive layer may frequently be peeled off the master or wrinkled by stress generated at the start of electroforming. This phenomenon occurs particularly frequently in those portions where no patterns are formed, i.e., unwritten portions or mirror portions. On observation under a light-shielding condition, therefore, the unwritten portions frequently look cloudy, in many cases. Actually, the surface roughness (Ra) of these portions increases. Although this problem can be suppressed by adjusting deposition conditions for the conductive film, current density at the start of electroforming, and temperature of the electroforming solution, it is very hard to achieve optimum conditions.

In order to restrain adhesion of a resist residue to the embossing surface (the patterned surface) of a stamper, there is proposed a method of manufacturing a stamper for patterning audio recording that includes a metallic layer (conductive film) of an nickel-vanadium alloy with a vanadium content of 3 to 30 percent, see JP-A 8-273220 (KOKAI). In this method, the nickel-vanadium conductive film is deposited on the embossing surface of a resist master and then nickel is electroformed. This method has an advantage that the stamper formed of the electroformed layer and the conductive film can be easily stripped from the master, and the embossing surface thereof is free from any resist residue after stripping.

According to this method, however, the adhesion between the resist pattern and the nickel-vanadium conductive film with vanadium content of 3 to 30 percent is poor. Thus, there is a problem that peeling of the conductive film may occur during the electroforming process or the surface roughness (Ra) may be increased by wrinkling.

### BRIEF SUMMARY OF THE INVENTION

According to an aspect of the present invention, there is provided a stamper comprising a stamper body including a nickel having a patterned surface by artificial drawing method; and a surface layer of a nickel-vanadium alloy having a vanadium content of less than 3 atomic percent formed on the patterned surface.

According to another aspect of the invention, there is provided a method of manufacturing a stamper comprising: preparing a master having a patterned surface by artificial drawing method; depositing a nickel-vanadium alloy having a vanadium content of less than 3 atomic percent on the patterned surface to form a surface layer; electroforming nickel on the nickel-vanadium alloy to form a nickel stamper body; and separating the surface layer and the nickel stamper body from the master.

### BRIEF DESCRIPTION OF THE SEVERAL VIEWS OF THE DRAWING

FIGS. 1A, 1B, 1C, 1D, 1E and 1F are sectional views for illustrating a method of manufacturing a stamper according to an embodiment of the present invention;

FIG. 2 is a chart, i.e., depth profile, showing results of measurement on a stamper sample according to an embodiment by secondary ion mass spectrometry (SIMS); and

FIG. 3 is a graph showing a relationship between the vanadium content of the surface layer and surface roughness Ra on an unwritten portion of a stamper.

### DETAILED DESCRIPTION OF THE INVENTION

The present inventors have found that, if nickel-vanadium alloy having vanadium content of 3 atomic percent or less is used as a conductive film for nickel electroforming, adhesion between the conductive film and a resist can be improved. They have also found that, when the adhesion between the conductive film and the resist is improved, the conductive film is hard to be peeled off the resist, so that the conductive film can avoid influence of stress produced at the start of electroforming, making it possible to reduce surface roughness of unwritten portions or mirror portions.

The stamper stripped from the master may have a large amount of resist adhered thereto. This is because the resist residue adhered to the stamper can be thoroughly removed with ease in a later process for removing the resist residue.

Embodiments of the present invention will now be described with reference to the accompanying drawings. The same numbers are used to designate common elements throughout the embodiments, and repeated description is omitted. The drawings are schematic views for easier understanding of the invention. Although the respective shapes, dimensions, and ratios of individual elements may be different from actual specifications, they may be suitably designed and modified in consideration of the following description and known techniques.

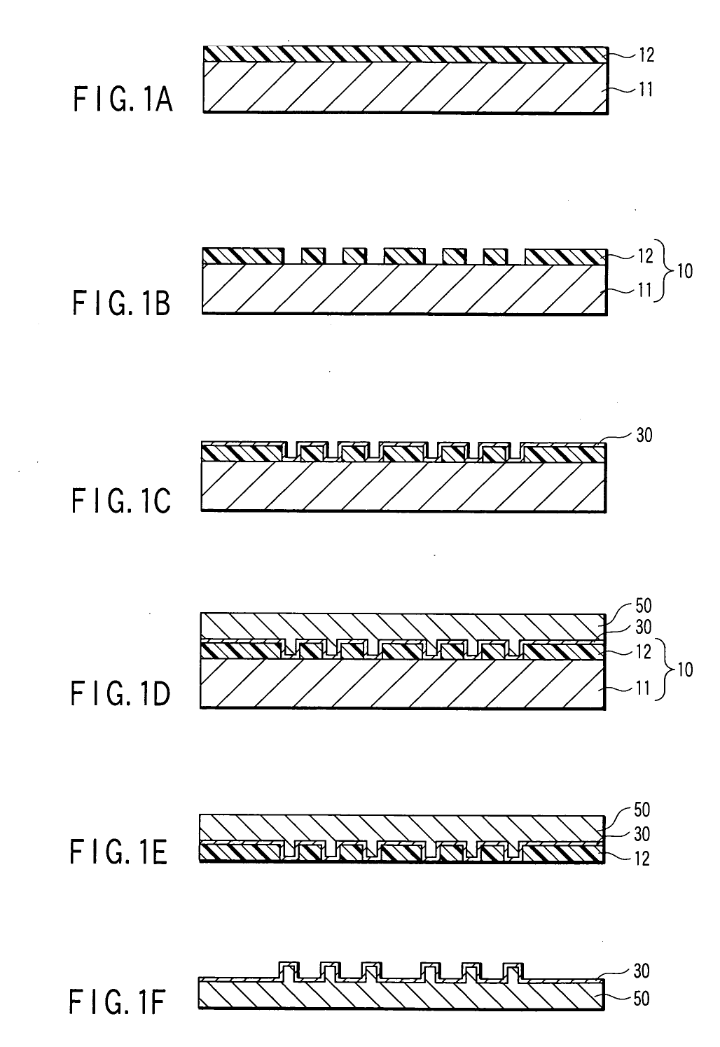

A method of manufacturing a stamper according to an embodiment of the invention will be described in brief with reference to the sectional views of FIGS. 1A to 1F.

As shown in FIG. 1A, a substrate 11 is spin-coated with resist 12 to which patterns are drawn by EB lithography. A semiconductor substrate, such as a silicon wafer, is used as the substrate 11. An electron-beam (EB) resist or the like is used as the resist 12.

As shown in FIG. 1B, the resist 12 is developed to form a master 10 having patterns where the recesses are portions irradiated with an electron beam.

As shown in FIG. 1C, an conductive film 30 of a nickel-vanadium alloy having a vanadium content of less than 3 atomic percent is deposited on the patterned surface of the master 10 by sputtering or chemical vapor deposition (CVD). In sputtering, a target of a nickel-vanadium alloy having a vanadium addition amount of less than 3 atomic percent is used.

As shown in FIG. 1D, an electroformed layer 50 of nickel is formed on the conductive film 30 by electroforming so as to transfer the protrusions of the master 10 thereto. Nickel or an alloy prepared by adding cobalt, sulfur, boron or phosphorus to nickel is used as a material for the electroformed layer 50. However, there is a possibility that impurities may be mixed in the material for the electroformed layer without intention.

As shown in FIG. 1E, vacuum break is started from an end portion of the master 10 to separate the electroformed layer 50 and the conductive film 30 from the master 10.

As shown in FIG. 1F, residues of the resist 12 are removed by oxygen etching to manufacture a stamper. This stamper includes the electroformed layer 50 or stamper body of nickel having a patterned surface and the conductive film 30 or surface layer of the nickel-vanadium alloy having a vanadium content of less than 3 atomic percent.

According to the embodiment of the invention, since the adhesion between the resist 12 and the conductive film 30 of the nickel-vanadium alloy having a vanadium content of less than 3 atomic percent is improved, the surface state of the resist master can be accurately transferred to the stamper not only in the exposed portions or patterned portions but also in the unwritten portions or mirror portions. Thus, there may be provided a high-quality stamper with reduced surface roughness.

An example of a method of manufacturing a stamper according to the embodiment of the invention will now be described more specifically.

A silicon wafer of 6-inch diameter with a surface roughness Ra of 0.3 nm is provided as the substrate. On the other hand, an EB resist ZEP-520 from Nippon Zeon Co., Ltd. is diluted twice with anisole and filtered by means of a membrane filter with a 0.2-μm pore diameter to prepare a resist solution. The silicon wafer is spin-coated with the resist solution and then pre-baked at 200° C. for 3 minutes to form a resist layer with a thickness of about 0.1 μm.

The silicon wafer is placed on the stage of an electron-beam exposure system that includes a ZrO/W electron gun emitter of a thermal field emission type, and patterns are drawn to the resist layer on the silicon wafer. For example, the electron beam drawing is performed at an acceleration voltage of 50 kV under the conditions that the stage is rotated at a constant linear velocity (CLV) of 700 mm/s and moved in radial direction thereof as required. In drawing concentric tracks, the electron beam is deflected with every revolution of the stage. In the drawing, drawing signals are transmitted from a signal source to the exposure system in synchronism with signals for controlling the exposure system, such as control signals for the stage drive system and electron beam deflection control signals.

The silicon wafer is rotated at 500 rpm by means of a spin coater to which wafer a developer ZED-N50 (Nippon Zeon Co., Ltd.) is dripped for 60 seconds to develop the resist layer. Thereafter, the wafer is rinsed with an organic solvent ZMD-B (Nippon Zeon Co., Ltd.) dripped thereon for 90 seconds. Thereafter, the wafer is rotated at a high speed of 3,000 rpm for spin drying to produce a master with patterned surface.

In order to deposit a conductive film by sputtering, the master is put into a sputtering chamber. The chamber is evacuated to a pressure of 8×10⁻³ Pa, and then is adjusted to a pressure of 1 Pa by introducing an argon gas into the chamber. A nickel-vanadium alloy added with 1 atomic percent of vanadium is used as a target to which DC power of 100 W is applied to perform sputtering for 2.5 minutes. Thus, a conductive film of the nickel-vanadium alloy with a thickness of about 20 nm is formed on the patterned surface of the master.

The master is immersed in a nickel sulfamate plating solution for 90 minutes of electroforming to form a nickel electroformed layer with a thickness of about 300 μm. Electroforming conditions include, for example, 600 g/L of nickel sulfamate, 40 g/L of boric acid, 0.15 g/L of surfactant (sodium lauryl sulfate), solution temperature of 50° C., pH of 4.0, and current density of 20 A/dm².

Vacuum break is started from an end portion of the master to separate the electroformed layer and the conductive film from the master. It is generally difficult to vertically separate the vacuum-chucked stamper and master. Therefore, the vacuum break is started from the end portion of the master, and the stamper is separated obliquely from the master. If a nickel-vanadium alloy containing less than 3 atomic percent of vanadium is used as the electroformed layer, the master and the stamper still held together can be rinsed with DI water to wash away a remaining electroforming solution, wiped and dried before the stamper is separated from the master. Accordingly, the stamper can be separated with a dried surface and in a clean state with any other substances than the resist residue. Thus, there may be provided a high-quality stamper that is free from contamination such as liquid spots on patterned surface.

After the rinsing and drying, the stamper is subjected to oxygen plasma ashing to remove resist residues adhered to the conductive film. For example, the chamber is supplied with an oxygen gas at a flow rate of 100 sccm so as to adjust the pressure to 4 Pa where oxygen plasma ashing is performed with a power of 100 W for 15 minutes. The oxygen plasma ashing can remove the resist residues but also cause the patterned surface to be covered with an oxide film, which serves as a releasing layer in a later duplicating process.

The resultant stamper is used as a father stamper which is handled in the same manner as the resist master by repeating the deposition of the nickel-vanadium conductive film, electroforming, separating, rinsing, drying, and oxygen plasma ashing. Thus, mother stampers with inverted protrusions are duplicated. Further, using the mother stampers, sun stampers with inverted protrusions, i.e., with the same shapes as the father stamper, are obtained. In such a manner, a plurality of mother stampers can be obtained from each father stamper, and a plurality of sun stampers from each mother stamper. The duplication may not always require use of the conductive film. Since the stamper equivalent to the master is covered with a very thin non-conductive oxide film, however, it is desirable to deposit the same conductive film as the one that is used in fabricating the father stamper from the resist master.

Since the duplication of the mother stampers requires neither the use of the resist nor the process of removing resist residues, the oxygen plasma ashing should be performed only for the formation of the oxide film as a release layer for the duplication of the sun stampers. Specifically, it is necessary only that the time for the oxygen plasma application be reduced to 3 minutes under the aforesaid conditions.

Since the sun stampers reproduce the shapes of the father stamper, they can be used as a mold, like the father stamper, in a process for transferring patterns to a desired substrate such as injection molding and imprinting.

The obtained father stamper or sun stamper is coated with SILITECT-II (Trylaner International), a protective film solution, with rotated at 100 rpm by means of the spin coater, and then is rotated at 500 rpm for 2 seconds to make a uniform film. The stamper coated with the protective film is placed on a hot plate at 60° C. and dried for 15 minutes.

A conventional nickel stamper is easily corroded on its surface by a chlorine component contained in the protective film. On the other hand, the stamper according to the present embodiment having the nickel-vanadium surface layer containing less than 3 atomic percent of vanadium has high corrosion resistance against chlorine.

After the protective film is dried, the electroformed surface is leveled off by back polishing as required, and the stamper is trimmed to a desired size. The stamper thus obtained can be used as a mold for manufacturing recording media such as magnetic disk by imprinting.

In the stamper according to the present embodiment, the surface layer formed of a nickel-vanadium alloy having a low content of vanadium shows properties similar to those of the nickel stamper body, so that the stamper body and the surface layer are highly compatible. Therefore, if the stamper is used for mass duplication of patterns by injection molding or imprinting, the surface layer would not be stripped from the stamper body, so that recording media with a high-accuracy shape can be successively manufactured. On the other hand, in the case of a stamper with a surface layer of, for example, a nickel-vanadium alloy containing about 8 atomic percent of vanadium, a diamagnet, the surface layer has different properties from those of the stamper body, so that the stamper body and the surface layer may possibly have poor compatibility.

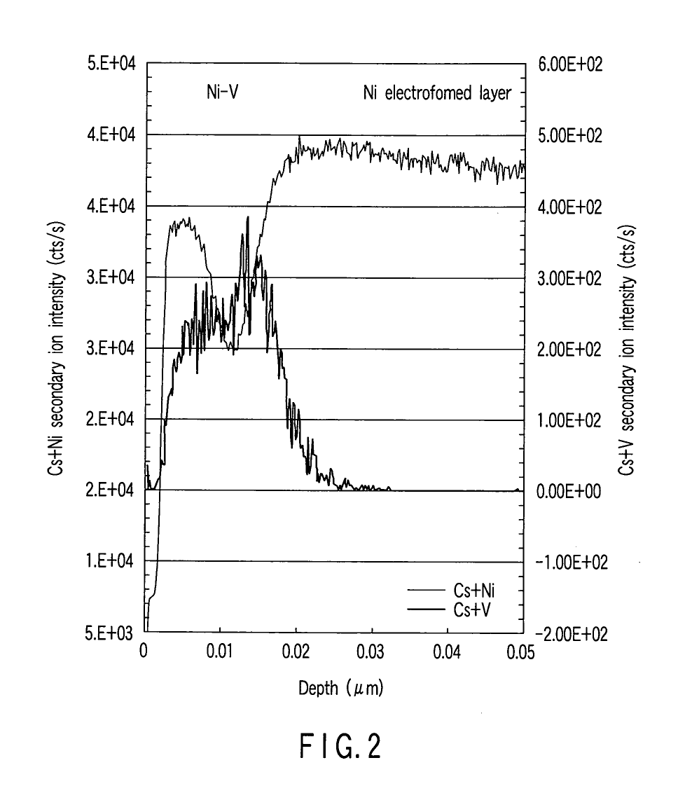

A stamper sample manufactured by using a sputtering target of nickel-vanadium alloy containing 1 atomic percent of vanadium, as described above, was analyzed for composition in the depth direction starting from the surface by means of a secondary ion mass spectrometer (SIMS). FIG. 2 shows measurement results (depth profiles) by SIMS for the stamper sample according to the embodiment.

Followings can be seen from FIG. 2. It is found that vanadium can be detected only to a depth of about 20 nm that is equivalent to the thickness of the conductive film. A small amount of releasing agent component contained in the protective film seems to remain on the outermost surface of the stamper, and a nickel-vanadium surface layer exists under the outermost surface. The nickel-vanadium surface layer is nickel-rich near the surface and becomes more vanadium-rich towards the depth direction. The result seems to show dependence on sputtering conditions with which the conductive film is formed. It is supposed that a nickel component in the target of the nickel-vanadium alloy is mainly sputtered in the initial stage of the sputtering process and then a vanadium component is sputtered.

Next, a sputtered film, deposited under the same conditions as above using a sputtering target of nickel-vanadium alloy containing 1 atomic percent of vanadium, was quantitatively analyzed for composition with an inductively-coupled plasma atomic emission spectrometer (ICP-AES). It was found that the sputtered film contained 99 atomic percent of nickel and 0.98 atomic percent of vanadium, representing a composition substantially equal to that of the target.

In addition, the stamper according to the embodiment comprising the nickel stamper body and the surface layer, i.e., the conductive film, deposited by using the sputtering target of nickel-vanadium alloy containing 1 atomic percent of vanadium was measured for surface roughness Ra of the unwritten portions or mirror portions with an atomic force microscope (AFM). Consequently, the stamper of the embodiment had a surface roughness Ra of 0.8 nm on an unwritten portion, which is close to 0.3 nm for Ra value of the substrate.

On the other hand, a conventional stamper including a nickel stamper body and a nickel surface layer has a surface roughness Ra of 1.2 nm on an unwritten portion.

For the sake of comparison, a stamper including a nickel stamper body and a surface layer of nickel-vanadium alloy containing 8 atomic percent (or 7 weight percent) of vanadium was manufactured and was measured for surface roughness. As a result, the stamper has a surface roughness Ra of 2.2 nm on an unwritten portion, which is nearly twice as large as the Ra value of 1.2 nm for the conventional stamper.

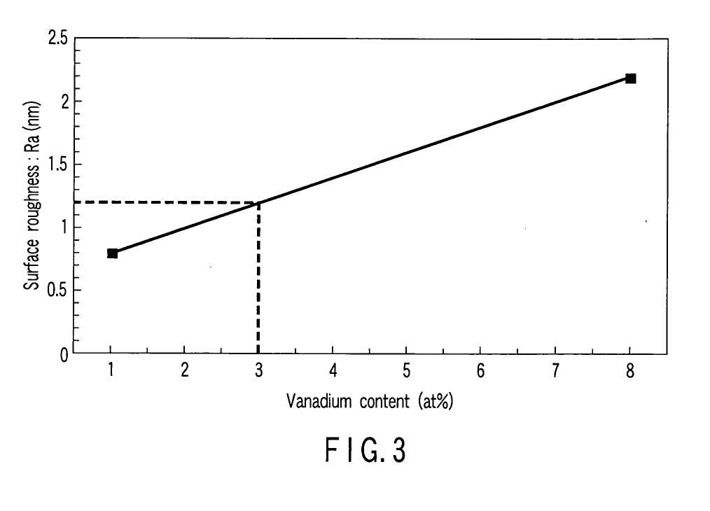

FIG. 3 shows a relationship between the vanadium content (atomic percent) of the surface layer or conductive film of the stamper and the surface roughness Ra (nm) on an unwritten portion of a stamper, based on the aforementioned results. As can be seen from FIG. 3, if the vanadium content of the surface layer or conductive film of the stamper is less than 3 atomic percent, the stamper has a surface roughness Ra on an unwritten portion smaller than the Ra value of 1.2 nm for a conventional stamper. In particular, if the vanadium content of the surface layer or conductive film of the stamper ranges from 1 to 2 atomic percent, the stamper has a surface roughness Ra of 1 nm or less on an unwritten portion. Such a stamper is free from clouds on unwritten portions in an inspection under a light-shielding condition, thus ensuring better properties.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A stamper comprising:
a stamper body including a nickel having a patterned surface by artificial drawing method; and
a surface layer of a nickel-vanadium alloy having a vanadium content of less than 3 atomic percent formed on the patterned surface.

2. The stamper according to claim 1, wherein the nickel-vanadium alloy of the surface layer has a vanadium content ranging from 1 to 2 atomic percent.

3. The stamper according to claim 1, wherein the surface layer has a thickness ranging from 5 to 200 nm.

4. A method of manufacturing a stamper, comprising:
preparing a master having a patterned surface by artificial drawing method;
depositing a nickel-vanadium alloy having a vanadium content of less than 3 atomic percent on the patterned surface to form a surface layer;
electroforming nickel on the nickel-vanadium alloy to form a nickel stamper body; and
separating the surface layer and the nickel stamper body from the master.

5. The method according to claim 4, wherein the nickel-vanadium alloy has a vanadium content ranging from 1 to 2 atomic percent.

6. A sputtering target comprising a nickel-vanadium alloy having a vanadium content of less than 3 atomic percent.

7. The sputtering target according to claim 6, wherein the nickel-vanadium alloy has a vanadium content ranging from 1 to 2 atomic percent.

8. A conductive film material for stamper electroforming comprising a nickel-vanadium alloy having a vanadium content of less than 3 atomic percent.

9. The conductive film material according to claim 8, wherein the nickel-vanadium alloy has a vanadium content ranging from 1 to 2 atomic percent.
